(19) United States
(12) Patent Application Publication
(10) Pub. No.: US 2006/0084044 A1
(43) Pub. Date: Apr. 20, 2006

(54) System and method for obtaining and exchanging career information

(76) Inventor: Yu Meng, Bronx, NY (US)

Correspondence Address: Yu Meng, 3512 Oxford Ave, # 3D, Bronx, NY, 10463, US

(21) Appl. No.: 11/252,142

(22) Filed: Oct. 17, 2005

Related U.S. Application Data
(60) Provisional application No. 60/619,986, filed on Oct. 19, 2004.

(51) Int. Cl. G09B 19/00

(52) U.S. Cl. 434/219

(57) ABSTRACT

The system and method of the invention allow laypersons to communicate with professionals in various career fields. Students can get information about various career fields before they decide which careers they want to engage in. People who are considering a career change can also get career information about different career fields that they may not be familiar with. Because people who are employed in various career fields can register in the system as professionals in their fields, the present invention is able to cover many fields and provides up-to-date information about them.

### CROSS-REFERENCE TO RELATED APPLICATION

This application claims priority to U.S. Provisional Patent Application Ser. No. 60/619,986, filed Oct. 19, 2004.

### FEDERALLY SPONSORED RESEARCH

Not Applicable

### SEQUENCE LISTING OR PROGRAM

Not Applicable

### BACKGROUND OF THE INVENTION

There are many careers and occupations in modern society. Many new careers and occupations are being created rapidly along with the development of new technologies.

When students want to choose their careers, they often have difficulty deciding on a particular field. People who want to change their current careers often face similar difficulties. Usually, they consult with their parents, teachers, and friends. Some of those people may know something about various careers but they probably will not know many details if they do not work in those fields themselves. Some books are recognized sources of career information, designed to provide valuable assistance to individuals making decisions about their future work lives. The books describe what workers do on the job, working conditions, the training and education needed, earnings, and expected job prospects in a wide range of occupations. Usually the books are revised every year or two. But because many fields change rapidly, it is difficult to keep the books up-to-date. Also, readers may have questions which are not answered in the books.

Fatseas, et al., U.S. Pat. No. 5,671,409, entitled “Computer-aided interactive career search system,” shows a method for accessing career information located in a computer database through interactive CD-ROM technology or other suitable computer-accessible means. The method involves the use of several levels of inquiry from which a user can select various careers, and for each career ask specific questions. The answers to these questions can be answered through digitized speech and video enactments of a person employed in a particular field, or through text displayed on a computer screen. Their system provides certain career information to users.

There are many disadvantages and limitations in the system. Because the information relating to career and occupational opportunities is stored in read-only memory, it is very difficult for the system to get up-to-date information about various career fields. Also, because the randomly selectable questions are predetermined, there are many limitations if users want to ask questions which are not included among the predetermined questions.

The present invention provides a communication system and method which allow laypersons to communicate with professionals. Because professionals employed in any field can contribute their expertise to the system at any time, the system will be able to make information from an unlimited number of fields available to the public. Laypersons can also ask questions of and get answers from professionals. Therefore, the communication system always has the capacity to provide up-to-date information about various careers.

### BRIEF SUMMARY OF THE INVENTION

It is an object of the invention to provide to students career information from professionals who are employed in particular fields.

It is another object of the invention to enable people who engage in different professions to exchange information about their careers.

Thus, the invention can introduce new graduates to various careers as well as enhance communication among people who are employed in different fields.

In the present invention, people who are not familiar with specific fields and want to obtain information about such fields are called laypersons; people who are employed in specific fields and who are willing to provide career information are called professionals.

Briefly, the present invention relates to a communication system and method for establishing communication routes among laypersons and professionals.

People who want to obtain or provide career information register in the communication system established by the present invention.

When laypersons want to obtain career information about a specific field, they can search for professionals in that field in the communication system. After they have found professionals who interest them, the laypersons can view those professionals' profiles. If they have questions, the laypersons can send their questions to the professionals.

The professional who received the question will respond and answer the question.

In general, the present invention provides a communication system and method for obtaining up-to-date career information from people who are employed in specific fields.

The above and other objects and advantages of the invention will become more readily apparent when reference is made to the description in conjunction with the accompanying drawings.

### BRIEF DESCRIPTION OF THE DRAWINGS

FIG. 1 is a diagram illustrating the location of the Communication System 106 of the present invention in a typical network system.

FIG. 2 is a block diagram illustrating the functionalities of the Layperson Module 110 in the Communication System 106 shown in FIG. 1.

FIG. 3 is a block diagram illustrating the functionalities of the Professional Module 114 in the Communication System 106 shown in FIG. 1.

FIG. 4 is a typical Layperson's Screen 402 when a layperson communicates with a professional.

FIG. 5 is a typical Professional's Screen 502 when a professional communicates with a layperson.

### DETAILED DESCRIPTION OF THE INVENTION

Glossary of Terminology

Layperson

A person who does not engage in a particular profession or who is not an expert in that field

Professional

One who engages in a pursuit or activity professionally; one employed in a particular career or occupation

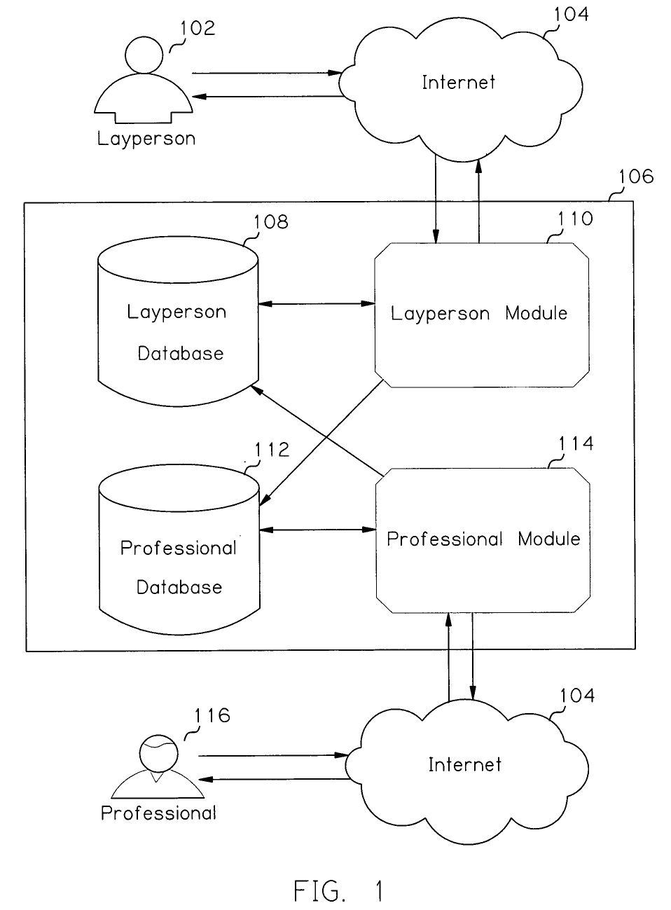

In the drawings, FIG. 1 is a diagram illustrating the location of the Communication System 106 of the present invention in a typical network system.

The Communication System 106 contains a Layperson Database 108, a Layperson Module 110, a Professional Database 112, and a Professional Module 114.

Layperson Database 108 contains information about a layperson's personal information and communication history with professionals. Professional Database 112 contains a professional's profiles and communication history with laypersons.

The Communication System 106 exchanges data with Layperson 102 and Professional 116 through Internet 104.

By utilizing the Communication System 106, Layperson 102 can communicate with Professional 116 to get up-to-date career information.

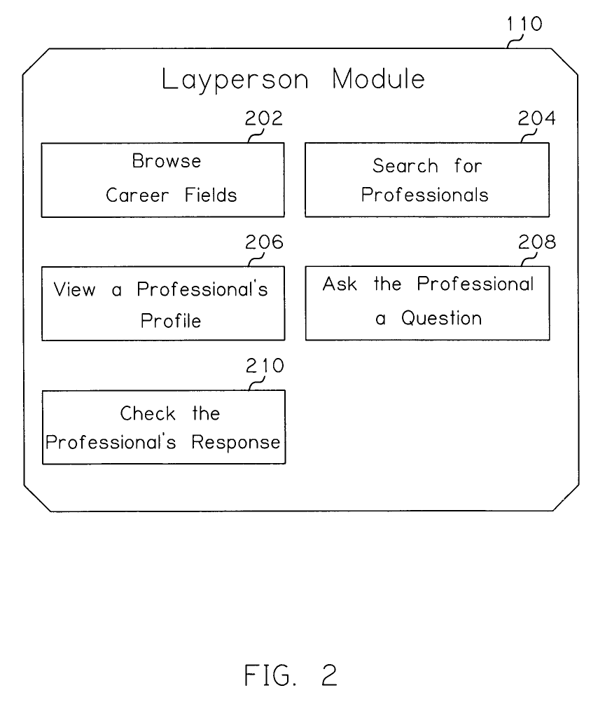

FIG. 2 is a block diagram illustrating the functionalities of the Layperson Module 110 in the Communication System 106 shown in FIG. 1.

The Layperson Module 110 consists of capabilities to Browse Career Fields 202, Search for Professionals 204, View a Professional's Profile 206, Ask the Professional a Question 208, and Check the Professional's Response 210.

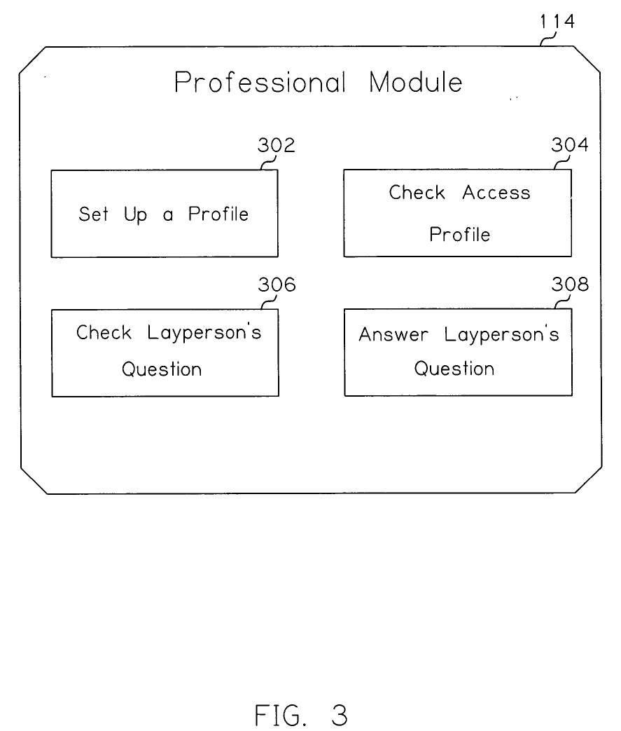

FIG. 3 is a block diagram illustrating the functionalities of the Professional Module 114 in the Communication System 106 shown in FIG. 1.

The Professional Module 114 consists of capabilities to Set Up a Profile 302, Check Access Profile 304, Check Layperson's Question 306, and Answer Layperson's Question 308.

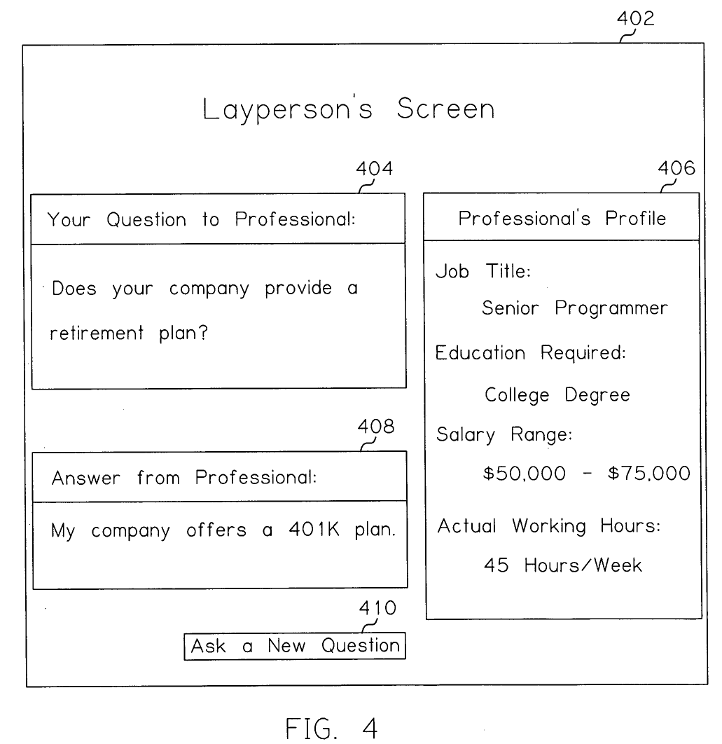

FIG. 4 is a typical Layperson's Screen 402 when a layperson communicates with a professional.

The layperson can view a Professional's Profile 406. The Professional's Profile 406 consists of information about job title, education required, salary range, etc.

The layperson's question which was sent to the professional is shown in block area 404. The response from the professional for that question is shown in block area 408.

In this example, the layperson asked, “Does your company provide a retirement plan?” The professional answered, “My company offers a 401K plan.”

The layperson can ask a new question by clicking on Ask a New Question button 410.

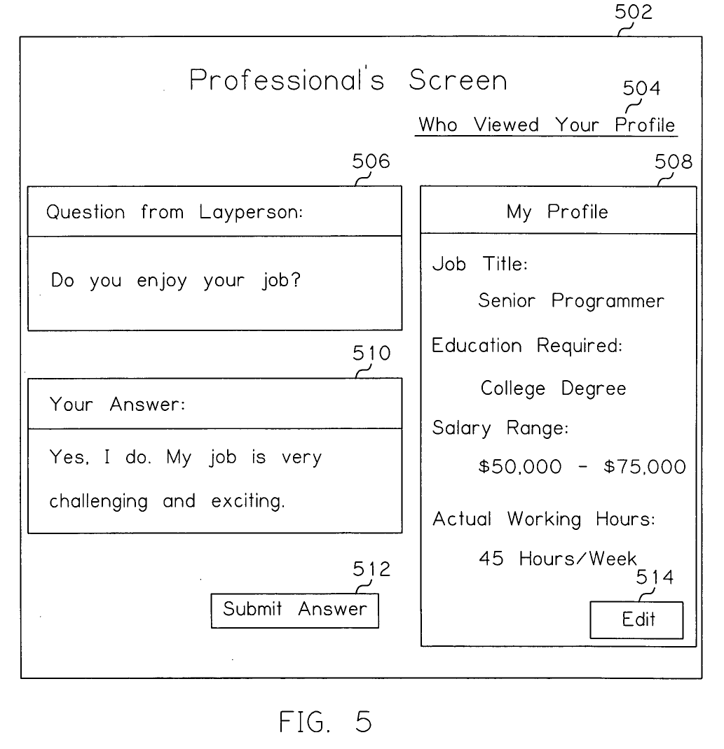

FIG. 5 is a typical Professional's Screen 502 when a professional communicates with a layperson.

The professional's profile is shown in My Profile 508. The professional can modify it by clicking on Edit button 514.

The professional can monitor the access log file by clicking on Who Viewed Your Profile 504.

The layperson's question was received and is shown in block area 506.

The professional can type the answer to the question in block area 510.

In this example, the layperson asked, “Do you enjoy your job?” The professional answered, “Yes, I do. My job is very challenging and exciting.”

By clicking on Submit Answer button 512, the professional can send the answer to the layperson.

### ADVANTAGES

From the description above, a number of advantages of the present invention become evident:

(a) Students can get career information by communicating with professionals in fields that they are interested in.

(b) Laypersons can get information about other career fields by communicating with professionals in those fields.

(c) Professionals in various fields can exchange information with one another.

(d) Anyone who is employed in a particular field can register in the system as a professional in that field. The system is able to encompass many fields.

(e) Because professionals who are currently engaged in certain fields provide information, the career information is always up-to-date.

### CONCLUSION AND SCOPE

Accordingly, readers can see that the present invention can allow laypersons to communicate with professionals and get up-to-date information about various fields.

By communicating with one another, people can share career information. Students can get very useful information when they need to choose a career.

Although the present invention has been described in detail, it will be understood that this description is not intended to limit the invention to this embodiment. Instead, it is intended to cover all alternatives, modifications, and equivalents as may be included within the spirit and scope of the present invention as defined by the appended claims.

I claim:

1. A communication system for obtaining and exchanging career information by allowing laypersons to communicate with professionals in specific career fields over a network, comprising:
a database for storing professionals' profiles; and
means for laypersons to access professionals' profiles; and
means for laypersons to communicate with professionals.

2. The communication system as recited in claim 1 wherein said database storing professionals' profiles contains data selected from the group consisting of:
professionals' personal information,
basic career information about professionals.

3. The communication system as recited in claim 1 wherein said means for laypersons to access professionals' profiles comprises:
means for laypersons to search for professionals in specific career fields;
means for laypersons to view professionals' profiles.

4. The communication system as recited in claim 1 wherein said means for laypersons to communicate with professionals comprises:
means for laypersons to ask questions of professionals; and
means for laypersons to receive responses from professionals.

5. A communication method for obtaining and exchanging career information by allowing laypersons to communicate with professionals in specific career fields over a network, comprising the steps of:
storing professionals' profiles in a database; and
allowing laypersons to access professionals' profiles; and
allowing laypersons to communicate with professionals.

6. The communication method as recited in claim 5 wherein said storing professionals' profiles in a database comprises the steps of:
storing professionals' personal information in said database;
storing basic career information about professionals in said database.

7. The communication method as recited in claim 5 wherein said allowing laypersons to access professionals' profiles comprises the steps of:
allowing laypersons to search for professionals in specific career fields;
allowing laypersons to view professionals' profiles.

8. The communication method as recited in claim 5 wherein said allowing laypersons to communicate with professionals comprises the steps of:
allowing laypersons to ask questions of professionals; and
allowing laypersons to receive responses from professionals.
